(19) United States
(12) Patent Application Publication
(10) Pub. No.: US 2026/0099457 A1
(43) Pub. Date: Apr. 9, 2026

(54) CONTROL DEVICE, CONTROL SYSTEM AND CONTROL METHOD FOR CONTROLLING A QUBIT OF A QUANTUM COMPUTER CONTROL CHANNEL

(71) Applicant: Rohde & Schwarz GmbH & Co. KG, München (DE)

(72) Inventor: Christoph Ruehle, Munich (DE)

(21) Appl. No.: 18/898,592

(22) Filed: Sep. 26, 2024

(51) Int. Cl. G06F 13/42

(52) U.S. Cl. CPC G06F 13/4282; G06F 2213/0002

(57) ABSTRACT

The present invention provides, a device for a controlling a quantum computer is provided. The device comprises a Quantum Computer Control System, QCCS, channel. The QCCS channel comprises a transceiver configured generate a 1-bit pulse stream and modulate the 1-bit pulse stream by pulse density modulation to generate a modulated signal, a low pass filter configured to filter the modulated signal and output a corresponding qubit control signal for a quantum computer. The invention further comprises a corresponding system, method and a use of a transceiver for controlling a qubit of a quantum computer.

### TECHNICAL FIELD OF THE INVENTION

The present disclosure relates to a control device for quantum computing systems. Specifically, the present disclosure pertains to a quantum computer control system (QCCS) channel designed to generate and modulate control signals, utilizing a transceiver and low pass filter to generate and output qubit control signals for controlling a qubit of a quantum computers. The present disclosure further relates to a control system and method.

### TECHNICAL BACKGROUND

Recently, superconducting qubits, such as Transmon and Fluxonium Qubits or Spin Qubits may be controlled via pulse sequences generated by arbitrary waveform generators (AWG). Such an AWG typically consists of an FPGA generating digital waveform data, which a digital to analog Converter (DAC) then converts to analog waveforms. Optional analog signal processing elements, such as amplifiers and filters, modify the analog signal e.g. to increase its amplitude or filter out unwanted frequency components, see attached drawing. The digital interface between FPGA and DAC together with the DAC itself are system components, which take large amounts of design resources and space on a printed circuit board (PCB) and increase power consumption of the system. However, future quantum computers will contain thousands of qubits, which then also need thousands of AWG channels for control.

The problem to be solved is thus how to reduce the resources and cost of signal generation for controlling qubits of a quantum computer.

### SUMMARY OF THE INVENTION

According to the invention, this problem is solved in each case by the subject matters of the independent claims.

According to a first aspect of the invention, a device for a controlling a qubit of a quantum computer is provided. The device comprises a Quantum Computer Control System, QCCS, channel. The QCCS channel comprises a transceiver configured generate a 1-bit pulse stream and modulate the 1-bit pulse stream by pulse density modulation to generate a modulated signal, a low pass filter configured to filter the modulated signal and output a corresponding qubit control signal for a quantum computer.

According to a second aspect of the invention, a system for controlling qubits of a quantum computer is provided. The system comprises a plurality of devices for a controlling a qubit of a quantum computer is provided. Each device comprises a Quantum computer control system, QCCS, channel. The QCCS channel comprises a transceiver configured generate a 1-bit pulse stream and modulate the 1-bit pulse stream by pulse density modulation to generate a modulated signal, a low pass filter configured to filter the modulated signal and output a corresponding qubit control signal for a quantum computer.

According to a third aspect of the invention, a control method for controlling a qubit of a quantum computer is provided. The method comprises generating a 1 bit pulse stream, modulating the 1 bit pulse stream by pulse density modulation to generate a modulated signal, applying a low pass filter to the modulated signal to output a qubit control signal.

According to a fourth aspect of the invention, a use of a transceiver and a low pass filter to control a qubit of a quantum computer is provided.

A fundamental idea of the present invention is to exploit standard transceivers signal generators for the use to control qubits of a quantum computer. Such transceivers are integrated in standard electronic components and may provide data rates above 30 GHz. Using a digital 1 bit digital to analog converters, DAC, such a transceiver can generate signal frequencies up to 15 GHz. By using pulse density modulation, a low frequency waveform is modulated on the 1 bit pulse stream, which can be used to control a qubit of a quantum computer.

Advantageous embodiments and further developments emerge from the description with reference to the figures.

According to an embodiment of the first aspect according to the invention, the transceiver is configured as a high speed Serializer/Deserializer, SERDES, transceiver, which is configured to receive a parallel control signal, convert the parallel control signal into a serial control signal and modulate the serial control signal onto the 1-bit pulse stream to generate the modulated signal.

According to an embodiment of the first aspect according to the invention, the transceiver is configured to send and/or receive data with a rate of more than 10 Gbps, preferably more than 25 Gbps.

According to an embodiment of the first aspect according to the invention, the QCCS channel further comprises a sigma delta modulator configured to generate the pulse density modulated signal.

According to an embodiment of the first aspect according to the invention, the sigma delta modulator is of a 1^{st} order and includes an integrator, a serial flip-flop register receiving a clock signal, and a comparator.

According to an embodiment of the first aspect according to the invention, the device further comprises a digital to analog converter, DAC, configured to convert the modulated signal into a corresponding analog modulated signal.

According to an embodiment of the first aspect according to the invention, the low pass filter is integrated into the transceiver.

According to an embodiment of the first aspect according to the invention, a bandwidth of the qubit control signal is within 100 MHz to 1 GHz.

According to an embodiment of the first aspect according to the invention, the device further comprises an up-conversion element comprising a local oscillator having a first frequency, which is higher than a bandwidth of the qubit control signal, wherein an output of the local oscillator is added to the qubit control signal to create an up-converted qubit control signal, wherein the up-conversion element further comprises a band pass filter for filtering a passband of the up-converted qubit control signal.

According to an embodiment of the second aspect according to the invention, the system further comprises a field-programmable gate array, FPGA, wherein the plurality of transceivers of the plurality of QCCS channels in each device is integrated in the FPGA.

According to an embodiment of the second aspect according to the invention, the FPGA is a standard off-the-shelf FPGA.

According to an embodiment of the second aspect according to the invention, an application-specific integrated circuit, ASIC, wherein the plurality of transceivers of the plurality of devices is integrated in the ASIC.

According to an embodiment of the third aspect according to the invention, the method further comprises receiving a control signal for a quantum computer, modulating the 1 bit pulse stream by the control signal by pulse density modulation to generate the modulated signal, converting the modulated signal into an analog modulated signal by using a digital to analog, DAC, converter.

According to an embodiment of the fourth aspect according to the invention, the transceiver is configured as a high speed Serializer/Deserializer, SERDES, transceiver, which is configured to receive a parallel control signal and convert the parallel control signal into a serial control signal and modulate the serial control signal onto the 1-bit pulse stream to generate the modulated signal.

According to an embodiment of the fourth aspect according to the invention, the SERDES transeiver is integrated in a field-programmable gate array, FPGA.

According to an embodiment of the fourth aspect according to the invention, the SERDES transeiver is integrated in an application-specific integrated circuit, ASIC.

The above embodiments and further developments can be combined with each other as desired, if useful. In particular, all features of the device for controlling a quantum computer are transferable to the corresponding system and method for controlling a quantum computer or the use of transceiver, and vice versa. Further possible embodiments, further developments and implementations of the invention also comprise combinations, not explicitly mentioned, of features of the invention described before or below with respect to the embodiments. In particular, the skilled person will thereby also add individual aspects as improvements or additions to the respective basic form of the present invention.

### BRIEF SUMMARY OF THE DRAWINGS

The present invention is explained more specifically below on the basis of the exemplary embodiments indicated in the schematic figures, in which:

FIG. 1 illustrates a highly schematic block diagram of a device for controlling a qubit of a quantum computer according to an embodiment of the invention;

FIG. 2 illustrates a highly schematic block diagram of a device for controlling a qubit of a quantum computer according to a further embodiment of the invention;

FIG. 3 illustrates a highly schematic block diagram of a system for controlling qubits of a quantum computer according to an embodiment of the invention;

FIG. 4 illustrates a highly schematic block diagram of a system for controlling qubits of a quantum computer according to a further embodiment of the invention;

FIG. 5 illustrates a highly schematic block diagram of a system for controlling qubits of a quantum computer according to a further embodiment of the invention;

FIG. 6 illustrates a highly schematic block diagram of a sigma delta modulator applicable in a device for controlling a qubit of a quantum computer according to a further embodiment of the invention;

FIG. 7 shows an embodiment of a device for controlling a qubit of a quantum computer according to a further embodiment of the invention; and

FIG. 8 shows a schematic flowchart of a method for controlling a qubit of a quantum computer.

In the figures of the drawing, elements, features and components which are identical, functionally identical and of identical action are denoted in each case by the same reference designations unless stated otherwise.

### DESCRIPTION OF EXEMPLARY EMBODIMENTS

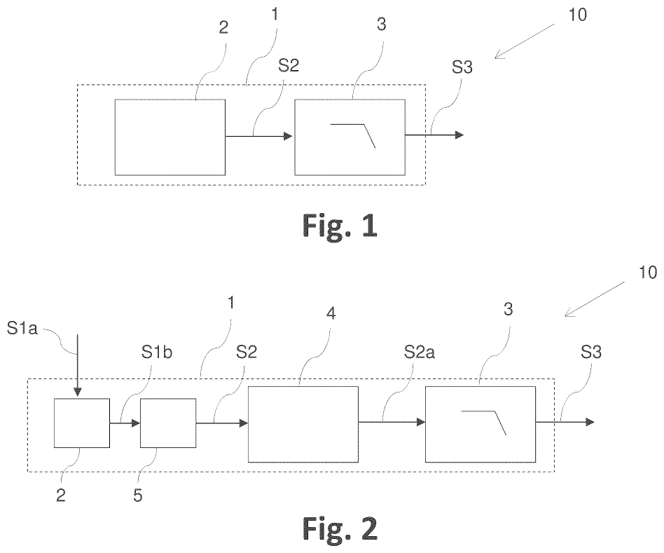

FIG. 1 shows a highly schematic block diagram of a device 10 for controlling a qubit of a quantum computer according to an embodiment of the invention. The device 10 comprises a Quantum Computer Control System, QCCS, channel 1. The QCCS channel 1 includes a transceiver 2 and a low pass filter 3. The transceiver 2 is configured to generate a 1 bit pulse stream. The transceiver 2 then modulates the 1 bit pulse stream by pulse density modulation to generate a pulse density modulated signal S2. The modulated signal S2 is then passed through the low pass filter 3, which filters the signal to produce a corresponding qubit control signal S3 for the quantum computer.

The transceiver 2 is thus able to generate a 1 bit pulse stream and modulate information onto the pulse stream, so that a pulse density modulated signal S2 is generated. The information may be provided manually by an operator or by a control signal S1 as described further below. Using a low pass filter 3, the original waveform shape of the control signal is then recovered and sent as a qubit control signal S3 to a qubit in a quantum computer.

The transceiver 2 is a standard transceiver, which is commonly used in electronic elements. In a preferred embodiment, the transceiver 2 is configured as a high speed Serializer/Deserializer, SERDES.

A particular advantage in the solution using standard transceivers as arbitrary waveform generators, AWGs, are lower power consumption, higher stability over temperature, higher linearity, in particular for a 1 Bit digital to analog converter, DAC, lower component count, allowing higher channel density and reduced cost. By using the combination of the transceiver 2 and the low pass filter 3, separate DAC components can be saved.

FIG. 2 shows a highly schematic block diagram of a device 10 for a controlling a qubit of a quantum computer according to a further embodiment of the invention.

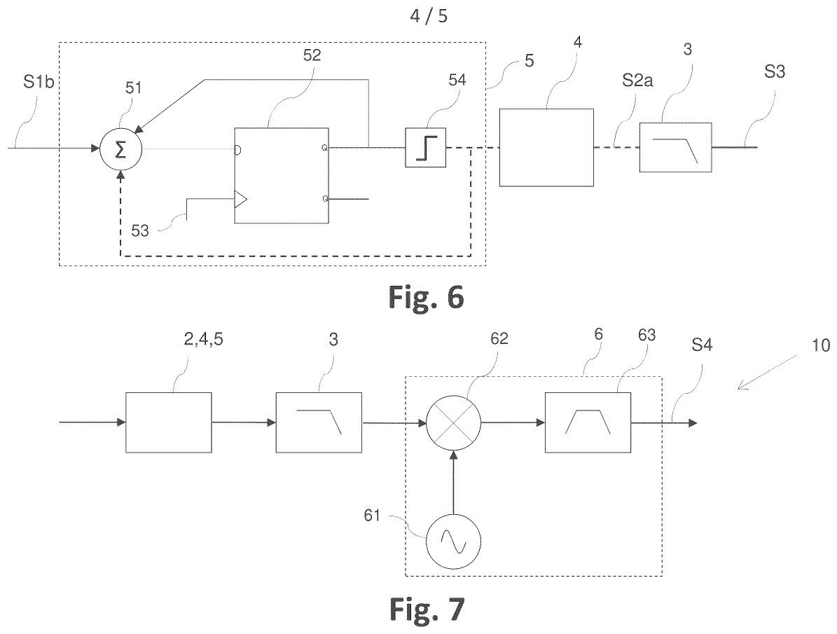

In this embodiment, the QCCS channel 1 receives a parallel control signal S1a. The transceiver 2 is configured as a high-speed Serializer/Deserializer SERDES transceiver and converts the parallel control signal S1a into a serial control signal S1b. The serial control signal S1b is then fed into a sigma delta modulator 5, which generates the pulse density modulated signal S2. In some embodiments, the sigma delta modulator 5 is of a 1st order. In further embodiments, the signal delta modulator 5 comprises an integrator 51, a serial flip-flop register 52 receiving a clock signal 53, and a comparator 54, as will be explained further below with reference to FIG. 6. In some embodiments, the transceiver 2 is configured to send and/or receive data with a rate of more than 10 Gbps, preferably more than 25 Gbps.

The modulated signal S2 is subsequently converted into an analog modulated signal S2a by a digital to analog converter, DAC 4. The analog modulated signal S2a is then processed by the low pass filter 3, which outputs the qubit control signal S3. This low pass filter 3 is designed to operate within a bandwidth range of 100 MHz to 1 GHz, ensuring that the output signal is within the optimal frequency range for qubit control. The qubit control signal S3 is thus within a bandwidth range of 100 MHz to 1 GHz, suitable for controlling the qubits in the quantum computer.

In both figures, the transceiver 2 and the low pass filter 3 are integral components of the QCCS channel 1, working in tandem to modulate and filter the control signals to produce the desired qubit control signals S3 having an arbitrary waveform. The embodiments demonstrate the systematic flow of signals from the input control signal to the final qubit control signal S3.

The device 10, as illustrated in these FIGS. 1 and 2, is designed to handle high-speed data rates, with the transceiver 2 capable of sending and/or receiving data at rates exceeding 10 Gbps, and preferably more than 25 Gbps. Additionally, in some embodiments, the low pass filter 3 is integrated into the transceiver 2, optimizing the design for compactness and efficiency.

Overall, FIGS. 1 and 2 provide a detailed schematic representation of the QCCS channel 1 within the device 10, showing the integration and operation of the transceiver 2 with integrated sigma delta modulator 5, DAC 4, and low pass filter 3 in generating and processing the control signals having arbitrary waveform necessary for quantum computing applications.

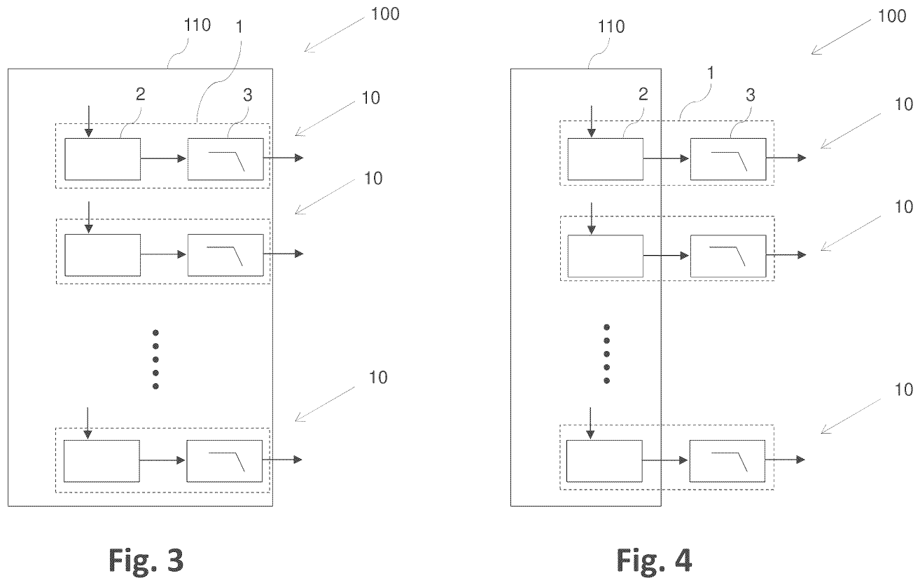

FIG. 3 shows a highly schematic block diagram of a system for controlling qubits of a quantum computer according to an embodiment of the invention.

The system 100 comprises multiple devices 10 similar and compatible to those described above with reference to FIGS. 1 and 2. Each device 10 includes a Quantum Computer Control System QCCS channel 1. The QCCS channel 1 is composed of a transceiver 2 and a low pass filter 3. The transceiver 2 is configured to receive a control signal S1 and modulate the control signal S1 onto a 1 bit pulse stream by pulse density modulation to generate a pulse density modulated signal S2. The low pass filter 3 is configured to filter the respective modulated signal S2 and output a corresponding qubit control signal S3.

The system 100 is integrated into a field-programmable gate array FPGA 110. The FPGA 110 houses multiple QCCS channels 1, each comprising a transceiver 2 and a low pass filter 3. Such an FPGA 110 houses a plurality of transceivers 2 that are being employed for generating the qubit control signals 3.

FIG. 4 shows a highly schematic block diagram of a system 100 for controlling qubits of a quantum computer according to a further embodiment of the invention. The system 100 is similar to the previous embodiment shown in FIG. 3 such that it also comprises multiple devices 10, each with a QCCS channel 1. Similar to FIG. 3, the QCCS channels 1 in this embodiment are also integrated into an FPGA 110 as well. Each QCCS channel 1 includes a transceiver 2 and a low pass filter 3. The transceivers 2 receive control signals, modulate them to generate pulse density modulated signals, and the low pass filters 3 filter these modulated signals to output qubit control signals having an arbitrary waveform. However, in this embodiment, the low pass filters 3 of the QCCS channels 1 are provided outside the FPGA 110 as external elements.

In both figures, the transceivers 2 are configured as high-speed Serializer/Deserializer SERDES transceivers, capable of receiving parallel control signals and converting them into serial control signals. These transceivers 2 can send and receive data at rates exceeding 10 Gbps, preferably more than 25 Gbps.

In some embodiments, the QCCS channels 1 further include sigma delta modulators 5 configured to generate pulse density modulated signals S2. These sigma delta modulators 5 are preferably of the 1st order. The modulated signals S2 generated by these modulators 5 are then converted into analog modulated signals S2a by DACs 4 before being filtered by the low pass filters 3.

The bandwidth of the qubit control signals S3 output by the low pass filters 3 is within the range of 100 MHz to 1 GHz, ensuring precise control of the qubits in the quantum computer. As modern FPGAs contain more than100 transceivers, such an FPGA can generate more than 100 qubit control signals S3 with this method, which leads to an increase in possible channel density by a factor of 5 to 10.

In some embodiments, the system 100 further includes an up-conversion element 6 comprising a local oscillator 61 with a frequency higher than the bandwidth of the qubit control signal, as will be described in more detail further below with reference to FIG. 7. The output of the local oscillator 61 is added to the qubit control signal by a mixer 62 to create an up-converted qubit control signal. This up-converted signal is then filtered by a band pass filter 64 to ensure only the desired frequency range is passed through. This is particularly useful for controlling Transmon qubit, which are less or completely insensitive to transitions to high excited states and hence less sensitive to signal imperfections.

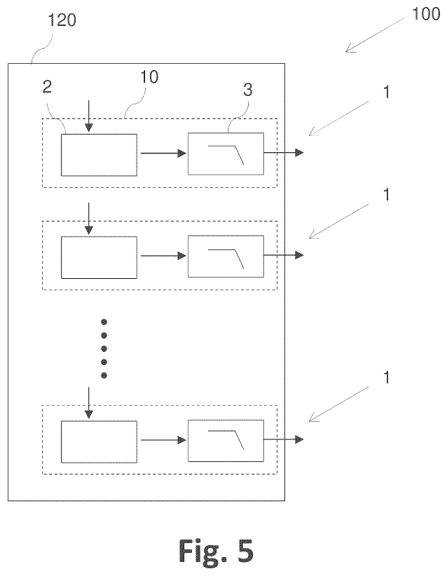

FIG. 5 shows a highly schematic block diagram of a system 100 for controlling qubits of a quantum computer according to a further embodiment of the invention. The device 10 is housed within an application-specific integrated circuit, ASIC 120, which integrates multiple Quantum Computer Control System QCCS channels 1.

Each QCCS channel 1 is similar and compatible with the QCCS channels 1 described above and comprises a transceiver 2, a sigma delta modulator 10, and a low pass filter 3. The transceiver 2 is configured to receive a control signal S1, which is modulated onto a 1 bit pulse stream to generate a pulse density modulated signal S2. A low pass filter 3 then filters the modulated signal S2 to produce a qubit control signal S3 having an arbitrary waveform signal suitable for controlling a qubit in a quantum computer. In some embodiments, the transceiver 2 is designed to handle high-speed data transmission, capable of receiving and processing control signals at rates exceeding 10 Gbps, and preferably more than 25 Gbps. The low pass filter 3 in each QCCS channel 1 is tasked with filtering the modulated signal to produce the final qubit control signal S3.

In the illustrated embodiment, multiple QCCS channels 1 are integrated within the ASIC 120, allowing for the simultaneous control of multiple qubits. This integration within a single ASIC enhances the overall efficiency and performance of the quantum computing system, reducing latency and improving signal integrity.

The arrows in FIG. 3 to 5 indicate the flow of digital signals between the components within each QCCS channel 1 and represent physical connections between the transceiver 2 and low pass filter 3. In this embodiment as well, a large number of QCCS channels 1 can be established using the transceivers 2 of the AISC. Overall, FIG. 5 provides a detailed schematic representation of the device 10, highlighting the integration and functionality of its key components within an ASIC 120.

FIG. 6 shows a highly schematic block diagram of an example sigma delta modulator 5 applicable in a device 10 for controlling a qubit of a quantum computer according to a further embodiment of the invention. The sigma delta modulator 5 comprises an integrator 51, a serial flip-flop register 52, a comparator 54, and a clock signal 53. The integrator 51 receives the digital serial control signal S1b and integrates it over time. The output of the integrator 51 is fed into the serial flip-flop register 52, which is clocked by the clock signal 53. The serial flip-flop register 52 outputs a signal that is compared by the comparator 54 to generate the pulse density modulated signal S2. This modulated signal S2 is then processed by a digital to analog converter DAC 4, which converts the digital modulated signal into an analog modulated signal S2a. The analog signal S2a is subsequently filtered by a low pass filter 3 to recover a low frequency analog waveform and thus produce the qubit control signal S3, which is used to control the qubits in the quantum computer.

FIG. 7 shows an embodiment of a device 10 for controlling a qubit of a quantum computer according to a further embodiment of the invention. The device 10 includes an up-conversion element 6. The input signal, which may be the qubit control signal S3, is first processed by a transceiver 2, 4, 5. This transceiver 2 is responsible for performing necessary modulation and conversion to generate a pulse density modulated signal S2. The output of the transceiver 2 is then passed through a low pass filter 3 to ensure that only the desired frequency components of the signal S2 are retained.

The filtered signal is then fed into a mixer 62, which is part of the up-conversion element 6. The mixer 62 receives a local oscillator signal from a local oscillator 61. The local oscillator 61 generates a signal at a first frequency, which is higher than the bandwidth of the qubit control signal S3. The mixer 62 combines the filtered signal with the local oscillator signal to produce an up-converted qubit control signal S4. This up-converted signal S4 is then passed through a band pass filter 63, which filters out any unwanted frequency components, allowing only the desired passband of the up-converted qubit control signal S4 to pass through.

The components described in FIGS. 6 and 7 ensures precise control of qubits in a quantum computer by employing advanced modulation techniques and signal processing components. The sigma delta modulator 5 in FIG. 6 provides high-resolution digital to analog conversion that are sufficient for controlling e.g. Flux-Qubits. Further, the up-conversion element 6 in FIG. 7 allows for frequency translation of the control signals to higher frequencies, which can be advantageous for certain quantum computing applications. Such application may involve Transmon or Electron Spin qubits, which are less or completely insensitive to transitions to high excited states and hence less sensitive to signal imperfections. For controlling such Transmon or Spin qubits, excitation frequencies up to 10 or 20 GHz are required. For achieving those frequencies, a simple frequency up-conversion scheme is sufficient.

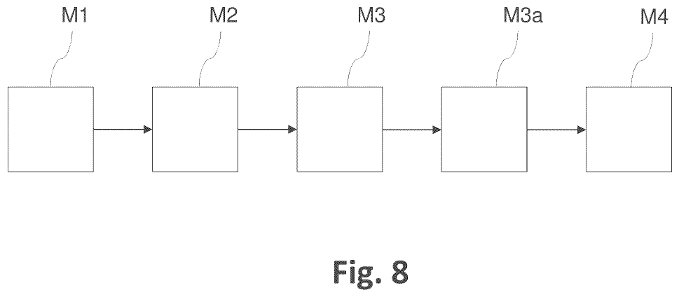

FIG. 8 illustrates a flowchart depicting the method for controlling a qubit of a quantum computer. The flowchart comprises five sequential operations, labeled M2 through M4, with additional, optional, sub-operations M1 and M3a.

The first step, M1, involves receiving a control signal S1 containing information for the qubit of a quantum computer. Alternatively, information for a qubit of a quantum computer are received in other ways such as e.g. by an operator or by a random signal generator. In some embodiments, the received control signal S1 is a parallel control signal S1a. This operation has the function to initiate the control process by acquiring the necessary input signal, e.g. in a parallel format. In some embodiments, the parallel control signal S1a is generated by a control system or a similar device designed to interface with the quantum computer.

The second step, M2, involves generating a digital serial control signal S1b by a transceiver 2. In preferred embodiments, the transceiver 2 is configured as a high-speed Serializer/Deserializer SERDES transceiver, which converts the parallel control signal S1a into a serial control signal S1b. This conversion is important for subsequent modulation processes, as serial signals are more manageable for high-speed data transmission and processing.

The third step, M3, is directed to modulating the serial control signal S1b using pulse density modulation to generate a modulated signal S2. Pulse density modulation is a technique that varies the density of pulses to represent the amplitude of the signal. This modulation is crucial for encoding the control information into a format suitable for quantum computer operations.

The sub-step, M3a, involves converting the modulated signal S2 into an analog modulated signal S2a using a digital to analog converter, DAC 4. Since a quantum computers typically operate with analog signals, the conversion is beneficial so that the modulated signal S2 is in an analog format to control the qubits effectively.

The fourth step, M4, applies a low pass filter 3 to the modulated signal S2 to output a qubit control signal S3. The low pass filter 3 removes high-frequency components from the modulated signal S2, ensuring that the resulting qubit control signal S3 is within the desired frequency range. The filtered signal S3 is then used to control the qubits in the quantum computer, facilitating precise quantum operations.

In summary, the method involves receiving a control signal S1 or similar information for controlling the qubit, modulating the (serial) bit signal by pulse density modulation to generate a modulated signal S2, optionally converting the modulated signal to an analog format S2a, and applying a low pass filter to produce the final qubit control signal S3. Each operation contributes to the overall process, ensuring that the control signals are appropriately formatted and filtered for effective quantum computer control.

In the detailed description above, various features have been combined in one or more examples in order to improve the rigorousness of the illustration. However, it should be clear in this case that the above description is of merely illustrative but in no way restrictive nature. It serves to cover all alternatives, modifications and equivalents of the various features and exemplary embodiments. Many other examples will be immediately and directly clear to a person skilled in the art on the basis of his knowledge in the art in consideration of the above description.

The exemplary embodiments have been chosen and described in order to be able to present the principles underlying the invention and their application possibilities in practice in the best possible way. As a result, those skilled in the art can optimally modify and utilize the invention and its various exemplary embodiments with regard to the intended purpose of use. In the claims and the description, the terms “including” and “having” are used as neutral linguistic concepts for the corresponding terms “comprising”. Furthermore, use of the terms “a”, “an” and “one” shall not in principle exclude the plurality of features and components described in this way.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps, which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 Quantum Computer Control System channel
2 transceiver
3 low pass filter
4 digital to analog converter, DAC
5 Sigma delta modulator
6 up-conversion element
10 device
11 system
51 integrator
52 flip-flop register
53 clock signal
54 comparator
61 local oscillator
62 mixer
63 band pass filter
110 field-programmable gate array, FPGA
120 application-specific integrated circuit, ASIC
S1 control signal
S1a parallel control signal
S1b serial control signal
S2 modulated signal
S2a analog modulated signal
S3 qubit control signal
M1-M4 Method steps

What we claim is:

1. A control device for controlling a qubit of a quantum computer, control device comprising:
a Quantum Computer Control System, QCCS, channel, the QCCS channel comprising:
a transceiver configured to generate a 1-bit pulse stream and to modulate the control signal on the 1-bit pulse stream by pulse density modulation to generate a modulated signal, and
a low pass filter configured to filter the modulated signal and to output a corresponding qubit control signal for a quantum computer.

2. The device of claim 1, wherein the transceiver is configured as a high speed Serializer/Deserializer, SERDES, transceiver, which is configured to receive a parallel control signal, convert the parallel control signal into a serial control signal and modulate the serial control signal onto the 1-bit pulse stream to generate the modulated signal.

3. The device of claim 1, wherein the transceiver is configured to send and/or receive data with a rate of more than 10 Gbps, preferably more than 25 Gbps.

4. The device of claim 1, wherein the QCCS channel further comprises a sigma delta modulator configured to generate the pulse density modulated signal.

5. The device of claim 4, wherein the sigma delta modulator preferably is of a 1^{st} order and includes an integrator, a serial flip-flop register receiving a clock signal, and a comparator.

6. The device of claim 1, further comprising a digital to analog converter, DAC, configured to convert the modulated signal into a corresponding analog modulated signal.

7. The device of claim 1, wherein the low pass filter is integrated into the transceiver.

8. The device of claim 1, wherein a bandwidth of the qubit control signal (S3) is in the range between 100 MHz and 1 GHz.

9. The device of claim 1, further comprising an up-conversion element comprising a local oscillator having a first frequency, which is higher than a bandwidth of the qubit control signal, wherein an output of the local oscillator is added to the qubit control signal to create a up-converted qubit control signal, and wherein the up-conversion element further comprises a band pass filter for filtering a passband of the up-converted qubit control signal.

10. A control system for controlling qubits of a quantum computer, the system comprising a plurality of devices for controlling a qubit of a quantum computer, each device comprising:
a Quantum Computer Control System, QCCS, channel, the QCCS channel comprising:
a transceiver configured generate a 1-bit pulse stream and modulate the control signal on the 1-bit pulse stream by pulse density modulation to generate a modulated signal, and
a low pass filter configured to filter the modulated signal and output a corresponding qubit control signal for a quantum computer.

11. The system of claim 10, further comprising a field-programmable gate array, FPGA, wherein the plurality of transceivers of the plurality of QCCS channels in each device is integrated in the FPGA.

12. The system of claim 11, wherein the FPGA is a standard FPGA circuit.

13. The system of claim 10, further comprising an application-specific integrated circuit, ASIC, wherein the plurality of transceivers of the plurality of devices is integrated in the ASIC.

14. A control method for controlling a qubit of a quantum computer, the controll method comprising:
generating a 1 bit pulse stream;
modulating the 1 bit pulse stream by pulse density modulation to generate a modulated signal;
applying a low pass filter to the modulated signal to output a qubit control signal for a quantum computer.

15. The method of claim 14, further comprising:
receiving a control signal for a quantum computer;
modulating the 1 bit pulse stream by the control signal by pulse density modulation to generate the modulated signal;
converting the modulated signal into an analog modulated signal by using a digital to analog, DAC, converter.

16. A use of a transceiver and a low pass filter to control a qubit of a quantum computer.

17. The use of a transceiver of claim 16, wherein the transceiver is configured as a high speed Serializer/Deserializer, SERDES, transceiver, which is configured to receive a parallel control signal and convert the parallel control signal into a serial control signal and modulate the serial control signal onto the 1-bit pulse stream to generate the modulated signal.

18. The use of a transceiver of claim 17, wherein the SERDES transeiver is integrated in a field-programmable gate array, FPGA.

19. The use of a transceiver of claim 17, wherein the SERDES transeiver is integrated in an application-specific integrated circuit, ASIC.
